(19) United States
(12) Patent Application Publication
(10) Pub. No.: US 2026/0226866 A1
(43) Pub. Date: Aug. 6, 2026

(54) GAS TURBINE CONTROL DEVICE, GAS TURBINE CONTROL METHOD, AND GAS TURBINE CONTROL PROGRAM

(71) Applicant: MITSUBISHI HEAVY INDUSTRIES, LTD., Tokyo (JP)

(72) Inventors: Rei IKEDA, Tokyo (JP); Satoko FUJII, Tokyo (JP); Masahiko NAKAHARA, Tokyo (JP); Taiki MATSUDA, Tokyo (JP); Kazushige TAKAKI, Tokyo (JP)

(21) Appl. No.: 19/147,361

(22) PCT Filed: Feb. 26, 2024
(86) PCT No.: PCT/JP2024/006696

§ 371 Date: Jul. 11, 2025

(30) Foreign Application Priority Data
Mar. 20, 2023 (JP) 2023-043761

(51) Int. Cl. F02C 9/28; F02C 9/40

(52) U.S. Cl. CPC F02C 9/28; F02C 9/40; F05D 2270/306; F05D 2270/331

(57) ABSTRACT

This gas turbine control device is a control device for controlling a gas turbine provided with a combustor capable of co-firing a first fuel and a second fuel. The device controls the flow rate of the first fuel to be a flow rate target value when a load reduction request with respect to the gas turbine has been acquired. The flow rate target value when the load reduction request is acquired is set by correcting a basic flow rate target value of the first fuel, which is for achieving a load corresponding to the load reduction request through single firing of the first fuel, on the basis of a co-firing rate.

### TECHNICAL FIELD

The present disclosure relates to a gas turbine control device, a gas turbine control method, and a gas turbine control program.

The present application claims the benefit of priority based on Japanese Patent Application No. 2023-043761 filed to the Japanese Patent Office on Mar. 20, 2023, the content of which is incorporated herein by reference.

### BACKGROUND ART

A gas turbine that can be driven by using a combustion gas generated by the combustion of a fuel is known. The gas turbine is used for, for example, in a gas turbine power generation facility that generates power by connecting a generator to an output shaft of the gas turbine. In recent years, due to the increase in awareness of environmental issues, natural gas, which is clean energy, may be used as fuel in this type of gas turbine. The natural gas is mined from a gas field or the like as raw material natural gas, and is liquefied and purified to be used as liquefied natural gas (LNG).

For example, in a case where an event such as a decrease in electric power demand for the power generation facility or abnormality detection in an electric power system occurs, a load reduction request may be made to the gas turbine. In this case, in order to prevent a sudden increase in the rotation speed due to a decrease in the load of the gas turbine, a fuel flow rate supplied to a combustor is controlled to decrease. For example, PTLs 1 and 2 relate to gas turbine control at the time of such a load reduction. In PTL 1, it is disclosed that the flow rate of the fuel supplied to the combustor is reduced to a minimum fuel flow rate when the load of the gas turbine is shut off. In addition, in PTL 2, it is disclosed that the minimum fuel flow rate is set to be variable based on the concentration of the fuel supplied to the combustor.

### CITATION LIST

### Patent Literature

[PTL 1] Japanese Unexamined Patent Application Publication No. 2007-113487

[PTL 2] Japanese Unexamined Patent Application Publication No. 2-130226

### SUMMARY OF INVENTION

### Technical Problem

In recent years, development of a gas turbine capable of co-firing hydrogen or the like (a second fuel) having a relatively lower calorific value per unit volume than a fuel (a first fuel) such as LNG as described above has been promoted. In such a co-firing operation of the gas turbine, the flow rate of each fuel may be controlled such that a co-firing ratio reaches a predetermined value.

Here, in PTLs 1 and 2, in a case where a load reduction request is made, the fuel flow rate supplied to the combustor is instantaneously reduced to the minimum fuel flow rate to prevent a sudden increase in the rotation speed. However, in a case where a load reduction request is made for a gas turbine performing a co-firing operation, when the fuel flow rate to be supplied to the combustor is reduced regardless of the co-firing state, there is a concern that the operating state of the gas turbine may become unstable. Specifically, since the calorific value per unit volume of the second fuel such as hydrogen is lower than that of the first fuel such as LNG, when the load reduction is requested, in a case where the flow rate of the fuel supplied to the combustor is changed to the same minimum fuel flow rate as in the case of the first fuel being exclusively combusted, the probability of a misfire occurring in the gas turbine increases.

At least one embodiment of the present disclosure has been made in view of the above-described circumstances, and an object of the present disclosure is to provide a gas turbine control device, a gas turbine control method, and a gas turbine control program capable of stably maintaining an operating state when a load on a gas turbine is reduced.

### Solution to Problem

In order to solve the above problems, a gas turbine control device according to at least one embodiment of the present disclosure is a gas turbine control device for controlling a gas turbine including a combustor capable of co-firing a first fuel and a second fuel having a lower calorific value per unit volume than the first fuel, the gas turbine control device including:
a load reduction request acquisition unit for acquiring a load reduction request for the gas turbine;
a co-firing ratio acquisition unit for acquiring a co-firing ratio of the combustor at a time of acquisition of the load reduction request;
a flow rate target value setting unit for setting a flow rate target value of the first fuel when the load reduction request is acquired; and
a fuel flow rate control unit for controlling a flow rate of the first fuel to the flow rate target value in a case where the load reduction request is acquired,
in which the flow rate target value setting unit sets a basic flow rate target value of the first fuel for realizing a load corresponding to the load reduction request by exclusive combustion of the first fuel, by correcting the basic flow rate target value based on the co-firing ratio.

In order to solve the above problems, a gas turbine control method according to at least one embodiment of the present disclosure is a gas turbine control method for controlling a gas turbine including a combustor capable of co-firing a first fuel and a second fuel having a lower calorific value per unit volume than the first fuel, the gas turbine control method including:
a step of acquiring a load reduction request for the gas turbine;
a step of acquiring a co-firing ratio of the combustor at a time of acquisition of the load reduction request;
a step of setting a flow rate target value of the first fuel at a time of acquisition of the load reduction request; and
a step of controlling a flow rate of the first fuel to the flow rate target value in a case where the load reduction request is acquired,
in which in the step of setting the flow rate target value, a basic flow rate target value of the first fuel for realizing a load corresponding to the load reduction request by exclusive combustion of the first fuel is set by correcting the basic flow rate target value based on the co-firing ratio.

In order to solve the above-described problems, according to at least one embodiment of the present disclosure, there is provided a gas turbine control program for controlling a gas turbine including a combustor capable of co-firing a first fuel and a second fuel having a lower calorific value per unit volume than the first fuel, the program causing a computer device to execute:
a step of acquiring a load reduction request for the gas turbine;
a step of acquiring a co-firing ratio of the combustor at a time of acquisition of the load reduction request;
a step of setting a flow rate target value of the first fuel at a time of acquisition of the load reduction request; and
a step of controlling a flow rate of the first fuel to the flow rate target value in a case where the load reduction request is acquired,
in which in the step of setting the flow rate target value, a basic flow rate target value of the first fuel for realizing a load corresponding to the load reduction request by exclusive combustion of the first fuel is set by correcting the basic flow rate target value based on the co-firing ratio.

### Advantageous Effects of Invention

According to at least one embodiment of the present disclosure, it is possible to provide a gas turbine control device, a gas turbine control method, and a gas turbine control program that can stably maintain an operating state when a load on a gas turbine is reduced.

### BRIEF DESCRIPTION OF DRAWINGS

FIG. 1 is a diagram illustrating a schematic configuration of a gas turbine according to one embodiment.

FIG. 2 is a sectional configuration example of a combustor of FIG. 1.

FIG. 3 is a block diagram illustrating a functional configuration of a gas turbine control device according to one embodiment.

FIG. 4 is a block diagram illustrating a configuration of a flow rate target value setting unit in FIG. 3.

FIG. 5 is a time chart illustrating a temporal transition of an opening degree of a shutoff valve, a flow rate target value of fuel to be supplied to a combustor, and a co-firing ratio when a load reduction request is acquired at time point t1.

FIG. 6 is a block diagram illustrating a configuration example of a fuel distribution ratio setting unit of FIG. 3.

FIG. 7 is a time chart illustrating a temporal transition of the opening degree of the shutoff valve, the flow rate target value of fuel to be supplied to the combustor, the co-firing ratio, and a pilot fuel distribution ratio in a case where the load reduction request is acquired at the time point t1.

### DESCRIPTION OF EMBODIMENTS

Hereinafter, some embodiments of the present invention will be described with reference to the accompanying drawings. Meanwhile, configurations described in the embodiments or illustrated in the drawings are not intended to limit the scope of the invention, and are merely examples for description.

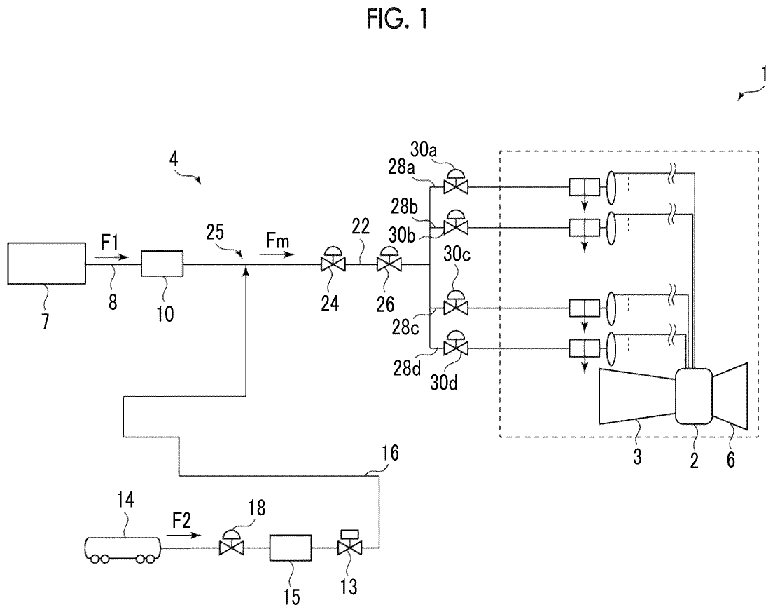

First, a gas turbine 1 which is a control target of a gas turbine control device 100 according to at least one embodiment of the present disclosure will be described with reference to FIG. 1. FIG. 1 is a diagram illustrating a schematic configuration of a gas turbine 1 according to one embodiment.

The gas turbine 1 includes a compressor 3 that generates compressed air, a combustor 2 that generates combustion gas by co-firing the compressed air generated by the compressor 3 with fuel, a fuel supply system 4 that supplies the fuel to the combustor 2, and a turbine 6 that is driven by the combustion gas. The compressor 3 and the turbine 6 are connected to each other on one shaft. In the gas turbine 1 having such a configuration, compressed air compressed by the compressor 3 and fuel supplied from the fuel supply system 4 are supplied to the combustor 2, and the compressed air and the fuel are mixed and combusted to generate combustion gas. The combustion gas flows into the turbine 6 and functions as power for driving the turbine 6.

The fuel supply system 4 handles a mixed fuel in which a first fuel F1 and a second fuel F2 are mixed with each other as the fuel supplied to the combustor 2. The second fuel F2 is a fuel having a lower calorific value per unit volume than the first fuel F1. In the present embodiment, the first fuel F1 is a liquefied natural gas (LNG), and the second fuel F2 is a hydrogen gas.

The first fuel F1 is supplied through a first fuel supply line 8 connected to a first fuel supply source 7. A flowmeter 10 for detecting the flow rate of the first fuel F1 is provided in the first fuel supply line 8.

The second fuel F2 is supplied through a second fuel supply line 16 connected to a second fuel supply source 14. The second fuel supply line 16 is provided with a first flow regulation valve 18 for adjusting the flow rate of the second fuel F2 and a shutoff valve 13 for shutting off the second fuel F2.

The first fuel supply line 8 and the second fuel supply line 16 are connected to a main fuel supply line 22 by joining to each other on a downstream side. The first fuel F1 and the second fuel F2 are mixed by being joined at a joining portion 25 of the first fuel supply line 8 and the second fuel supply line 16, and the mixed fuel (hereinafter, referred to as “mixed fuel Fm” as appropriate) is sent by the main fuel supply line 22. po In the main fuel supply line 22, a shutoff valve 24 that shuts off the mixed fuel Fm and a second flow regulation valve 26 that adjusts the flow rate of the mixed fuel Fm are provided.

The downstream side of the main fuel supply line 22 branches into a plurality of fuel branch supply lines 28a, 28b, . . . to correspond to a plurality of fuel injection nozzles included in the combustor 2. In the present embodiment, as will be described later, the plurality of fuel injection nozzles include a main fuel injection nozzle 52 and a pilot fuel injection nozzle 56, but may further include a top hat fuel injection nozzle or the like. In this case, at least some of the main fuel injection nozzles 52 may be grouped. The plurality of fuel branch supply lines 28a, 28b, . . . are respectively provided with third flow regulation valves 30a, 30b, . . . for adjusting the flow rate of the mixed fuel flowing through each line. Among the plurality of fuel branch supply lines 28a, 28b, . . . , the fuel branch supply lines 28a, 28b, and 28c are connected to the main fuel injection nozzle 52, and the fuel branch supply line 28d is connected to the pilot fuel injection nozzle 56.

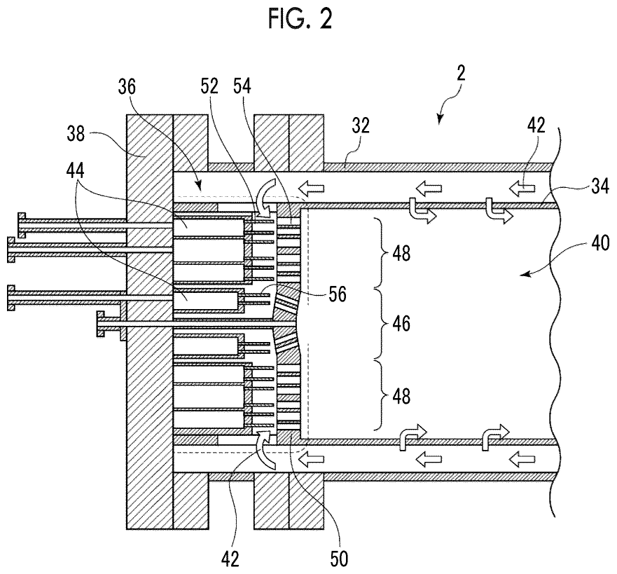

FIG. 2 is a sectional configuration example of the combustor 2 of FIG. 1. The combustor 2 includes an outer cylinder 32, a liner 34, a transition piece (not illustrated), and a burner 36. The outer cylinder 32 is a cylindrical member provided in an outer peripheral portion of a turbine casing (not illustrated). An end portion (head) of the outer cylinder 32 on an upstream side (left side in FIG. 2) is closed by an end cover 38. The liner 34 is a cylindrical combustor inner cylinder that forms a combustion chamber 40 inside, is installed inside the outer cylinder 32, and forms an annular air flow path between the liner 34 and the outer cylinder 32. A large number of air holes are formed in the liner 34. The combustion chamber 40 is a space formed between the burner 36 and the transition piece by the liner 34, and the fuel ejected from the burner 36 is combusted here together with air 42. The transition piece is a member that smoothly connects an inlet (first stage stator vane inlet) of a gas path of the turbine 6 and the liner 34. In addition, the end cover 38 is provided with a fuel distributor 44 that distributes fuel to the burner 36. In addition, although not specifically illustrated, the combustor 2 is also provided with an ignition device that ignites a fuel-air mixture in the combustion chamber 40.

The burner 36 is provided in the end cover 38 so as to be positioned between the combustion chamber 40 and the end cover 38. The burner 36 includes a plurality of element burners, one pilot burner 46 is disposed in a central portion of the combustor 2, and a plurality of main burners 48 are disposed on a radial outer side of the pilot burner 46 so as to surround the pilot burner 46.

Each main burner 48 includes an air hole plate 50 and a plurality of main fuel injection nozzles 52 as fuel injection nozzles. However, the air hole plates 50 of the plurality of main burners 48 are connected to each other. The air hole plate 50 is disposed such that a main surface (surface having the largest area) faces the combustion chamber 40, and has a plurality of air holes 54 extending in a direction from the end cover 38 toward the combustion chamber 40. The air 42 is injected from the air holes 54 into the combustion chamber 40. Each of the plurality of fuel injection nozzles 52 has the air hole 54 paired therewith, and each fuel injection nozzle 52 extends from the fuel distributor 44 to be coaxial with the corresponding air hole 54. In addition, although a tip of each fuel injection nozzle 52 may be inserted into the air hole 54 (located in the air hole 54), in the present embodiment, the tip is configured to face an inlet of the air hole 54 (located on the end cover 38 side with respect to the air hole plate 50). The gas fuel injected from the fuel injection nozzle 52 is injected into the combustion chamber 40 together with the air 42 passing through the air hole 54 via the air hole 54 having a corresponding relationship.

The pilot burner 46 has a configuration similar to that of the main burner 48 described above, and is located at the center of the plurality of main burners 48. The pilot burner 46 includes a pilot fuel injection nozzle 56 as a fuel injection nozzle.

Subsequently, the gas turbine control device 100 for controlling the gas turbine 1 having the above-described configuration will be described. The gas turbine control device 100 is a control unit that controls the gas turbine 1, and is configured with, for example, a central processing unit (CPU), a random-access memory (RAM), a read-only memory (ROM), a computer-readable storage medium, or the like. A series of processing for realizing various functions is stored in a storage medium or the like in the form of a program, as an example, and the CPU reads out this program to a RAM or the like, and executes processing for information processing and calculation, whereby various functions are realized. The program may be provided in a form installed in advance in the ROM or other storage medium, a form provided in a state of being stored in a computer-readable storage medium, or a form of being delivered via wired or wireless communication means. The computer-readable storage medium is a magnetic disk, a magneto-optical disk, a CD-ROM, a DVD-ROM, a semiconductor memory, or the like.

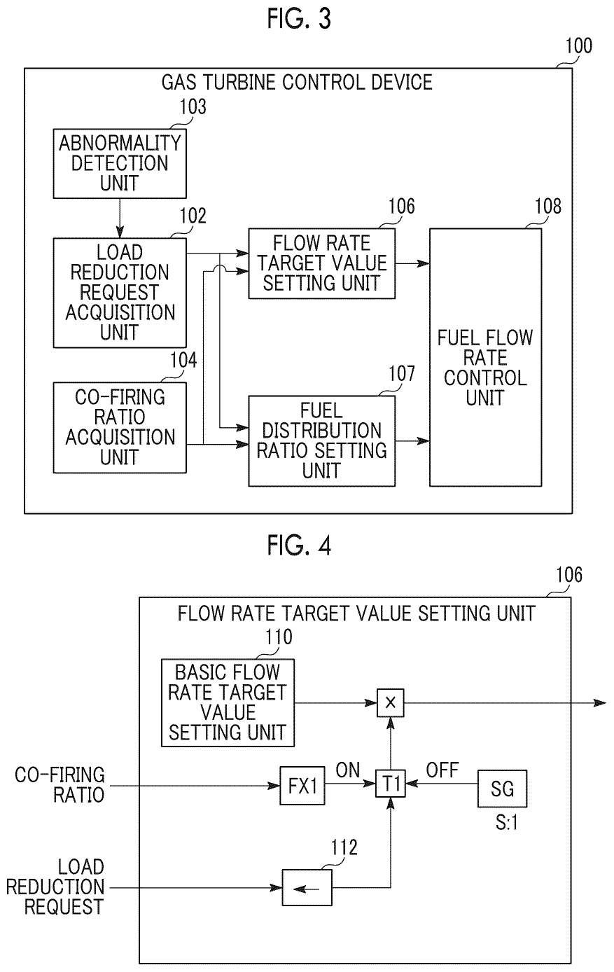

FIG. 3 is a block diagram illustrating a functional configuration of the gas turbine control device 100 according to one embodiment. The gas turbine control device 100 includes a load reduction request acquisition unit 102, an abnormality detection unit 103, a co-firing ratio acquisition unit 104, a flow rate target value setting unit 106, a fuel distribution ratio setting unit 107, and a fuel flow rate control unit 108.

The load reduction request acquisition unit 102 is configured to acquire a load reduction request for the gas turbine 1. The load reduction request is a command for requesting that the load of the gas turbine 1 be decreased compared to the current time, and may be, for example, a command for making the load of the gas turbine 1 less than a predetermined value. In the present embodiment, as an example of the load reduction request, a case will be described in which the abnormality detection unit 103 detects that the gas turbine is disconnected from a power transmission system and the load shutoff of the gas turbine power generation facility has occurred, and the command for making the load (output) of the gas turbine 1 zero is acquired.

The load reduction request is not limited to a command for reducing such a load to zero, and can broadly include a request command for operating the gas turbine 1 with a load smaller than the current load. In addition, acquiring the load reduction request includes not only the gas turbine control device receiving the load reduction request from another device but also generating the load reduction request via an internal process of the gas turbine control device.

The co-firing ratio acquisition unit 104 is configured to acquire the co-firing ratio at the time of acquisition of the load reduction request. The co-firing ratio may be acquired as a result of calculation based on, for example, the flow rate of the first fuel F1 acquired by the flowmeter 10 disposed in the first fuel supply line 8 and the flow rate of the second fuel F2 acquired by a flowmeter 15 disposed in the second fuel supply line 16. In addition, the co-firing ratio acquisition unit 104 may acquire a parameter related to the co-firing ratio instead of the co-firing ratio itself, and may acquire the co-firing ratio via calculation from the parameter.

The flow rate target value setting unit 106 is configured to set a flow rate target value CSO of the fuel to be supplied to the combustor 2 when the load reduction request is acquired. Here, the fuel supplied to the combustor 2 is a fuel flow rate of the mixed fuel Fm of the first fuel F1 and the second fuel F2 in a co-firing state, and is the fuel flow rate of the first fuel F1 in an exclusive combustion state of the first fuel. The fuel flow rate supplied to the combustor 2 can be regulated by the second flow regulation valve 26. The setting of the flow rate target value CSO will be described in detail later, but the setting is performed by correcting a basic flow rate target value CSOf1, which is a required fuel flow rate in a case where the load corresponding to the load reduction request is realized by the exclusive combustion of the first fuel F1, based on the co-firing ratio at the time of acquisition of the load reduction request.

The fuel distribution ratio setting unit 107 is configured to set a fuel distribution ratio for a specific fuel injection nozzle among the plurality of fuel injection nozzles included in the combustor 2. In the present embodiment, as an example of such a fuel distribution ratio, a distribution ratio (so-called pilot fuel ratio Dp1) of the amount of fuel supplied to the pilot fuel injection nozzle 56 with respect to the total fuel supply flow rate by the fuel supply system 4 is handled.

The fuel flow rate control unit 108 is configured to control the fuel flow rate via the fuel supply system 4. In a case where the load reduction request is acquired, the fuel flow rate control unit 108 controls the flow rate and the fuel distribution ratio of the first fuel F1 and the second fuel F2 based on the flow rate target value set by the flow rate target value setting unit 106 and the fuel distribution ratio set by the fuel distribution ratio setting unit 107.

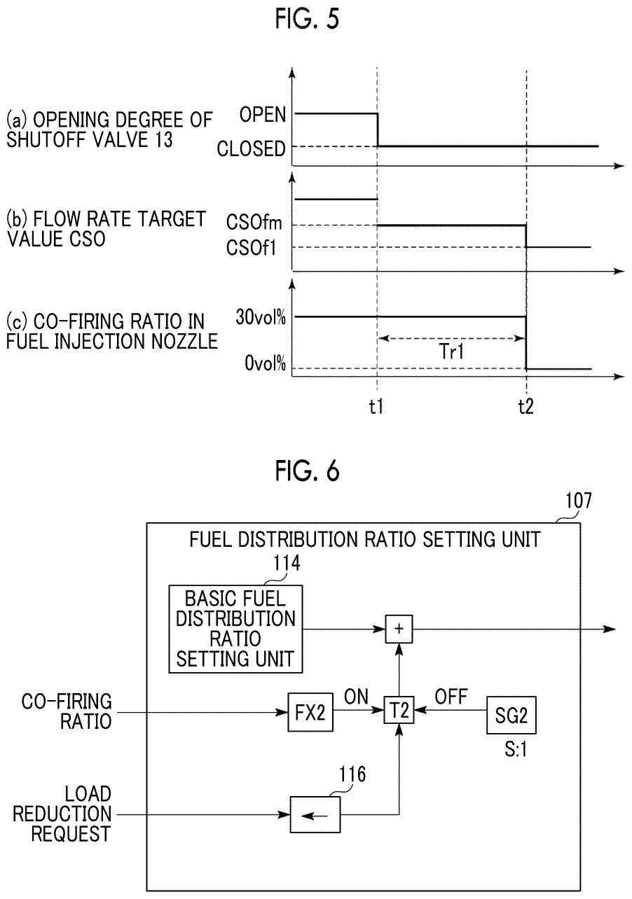

Here, the detailed configuration of the flow rate target value setting unit 106 will be described with reference to FIGS. 4 and 5. FIG. 4 is a block diagram illustrating the configuration of the flow rate target value setting unit 106 of FIG. 3, and FIG. 5 is a time chart illustrating a temporal transition of the opening degree of the shutoff valve 13, the flow rate target value CSO of the fuel supplied to the combustor 2, and the co-firing ratio in a case where a load reduction request is acquired at time point t1.

As illustrated in FIG. 4, the flow rate target value setting unit 106 includes a basic flow rate target value setting unit 110. The basic flow rate target value CSOf1 set by the basic flow rate target value setting unit 110 is determined to correspond to the load reduction request value during the exclusive combustion of the first fuel F1. In the present embodiment, since the load reduction request is a request for making the load of the gas turbine zero, the basic flow rate target value CSOf1 is set as a minimum flow rate value at which the gas turbine 1 can be operated when the first fuel F1 is exclusively combusted.

The flow rate target value setting unit 106 sets the flow rate target value CSO by correcting the basic flow rate target value CSOf1 based on the co-firing ratio as necessary. The effectiveness/ineffectiveness of such a correction is performed by switching control of a switch Tl based on the load reduction request acquired by the load reduction request acquisition unit 102.

The load reduction request is input to a timer 112 from the load reduction request acquisition unit 102. The timer 112 is configured to output an ON command to the switch T1 for a predetermined period Tr1 from a time point t1 when the load reduction request is input. Meanwhile, in a case where the load reduction request is not acquired or even in a case where the load reduction request is acquired, the switch T1 is switched to OFF after the predetermined period Tr1 has elapsed from the acquisition time point t1.

In addition, in the flow rate target value setting unit 106, a first correction value A1 is calculated by inputting the co-firing ratio acquired by the co-firing ratio acquisition unit 104 into a function FX1. The function FX1 is prepared in advance as a function that defines the correlation between the co-firing ratio and the first correction value A1. The first correction value A1 output from the function FX1 is multiplied by the basic flow rate target value CSOf1 for the predetermined period Tr1 from the time point t1 when the load reduction request is acquired by the load reduction request acquisition unit 102 and while the switch T1 is turned ON. Accordingly, the basic flow rate target value CSOf1 is corrected by the first correction value Al, so that the flow rate target value CSO is obtained.

In the example of FIG. 5, the load reduction request is acquired at the time point t1. Accordingly, in the flow rate target value setting unit 106, the switch T1 is switched to ON, so that the basic flow rate target value CSOf1 is corrected by the first correction value A1, and thus, a flow rate target value CSOfm larger than the basic flow rate target value CSOf1 is set. In this way, the flow rate target value CSO of the fuel flow rate in a case where the load reduction request is acquired is set based on the co-firing ratio. The flow rate target value CSO is obtained by correcting the basic flow rate target value CSOf1 based on the co-firing ratio such that the flow rate target value CSO becomes a load value (zero load corresponding to the load shutoff in the present embodiment) corresponding to the load reduction request. In this manner, even in a case where the fuel supplied to the combustor 2 is throttled so as to reduce the load of the gas turbine 1 in response to the load reduction request, the operating state of the gas turbine 1 can be stably maintained.

That is, when the load reduction request is acquired at the time point t1, the flow rate target value CSO is temporarily set to be greater than the basic flow rate target value CSOf1. In this manner, when the fuel flow rate is reduced such that the load of the gas turbine 1 is reduced by the load reduction request, it is possible to prevent the operating state of the gas turbine 1 from becoming unstable.

In the example of FIG. 5, in a case where the load reduction request is acquired, the shutoff valve 13 provided in the second fuel supply line 16 is switched to a fully closed state to shut off the supply of the second fuel F2. This is because, in a case where the fuel flow rate is minimized, it is easier to control the valve by controlling the flow rate of only the first fuel F1 having a larger calorific value per unit volume than by controlling the flow rates of both the first fuel F1 and the second fuel F2. After the shutoff valve 13 provided in the second fuel supply line 16 is switched to the fully closed state, the mixed fuel remaining in a fuel pipe from the joining portion 25 to the combustor 2 flows to the combustor 2 for a predetermined time Tr, and after the lapse of the predetermined time Tr, only the first fuel F1 flows to the combustor 2. Therefore, the flow rate target value setting unit 106 sets the basic flow rate target value CSOf1 as the flow rate target value CSO at time t2 when the predetermined period Tr1 has elapsed from the time point t1 when the load reduction request has been acquired. That is, the flow rate target value CSO is changed to the basic flow rate target value CSOf1 on a condition that a predetermined period Tr1 elapses from the time point t1 when the load reduction request is acquired. In this manner, since the predetermined period Tr1 from the time point t1 when the load reduction request is acquired is set to the flow rate target value greater than the basic flow rate target value CSOf1, it is possible to suppress the instability of the operating state of the gas turbine 1 due to the load change. Then, after the predetermined period Tr1 has elapsed, the flow rate target value CSO is set to the basic flow rate target value CSOf1, so that a low-load operating state of the gas turbine 1 due to the exclusive combustion of the first fuel F1 can be stably transitioned to.

The predetermined period Tr1 is set based on a required time for the mixed fuel of the first fuel F1 and the second fuel F2 to reach the combustor 2 from the joining portion 25 between the first fuel supply line 8 for supplying the first fuel F1 and the second fuel supply line 16 for supplying the second fuel F2. In this manner, when the second fuel F2 is shut off, the flow rate target value CSO of the fuel supplied to the combustor 2 is set to be larger than the basic flow rate target value CSOf1 until the mixed fuel remaining between the joining portion 25 and the combustor 2 reaches the combustor 2. In this manner, it is possible to suppress the instability of the operating state of the gas turbine 1 caused by throttling the fuel flow rate.

In the example of FIG. 5, when the load reduction request is acquired, the shutoff valve 13 provided in the second fuel supply line 16 is switched to the fully closed state. However, the supply of the second fuel F2 does not necessarily need to be shut off. In this case, it is not necessary to switch the switch T1 to OFF after the lapse of the predetermined period Tr1 by the timer 112, and the control may be performed such that the flow rate target value CSOfm corrected by the co-firing ratio is maintained even after the lapse of the predetermined period Tr1.

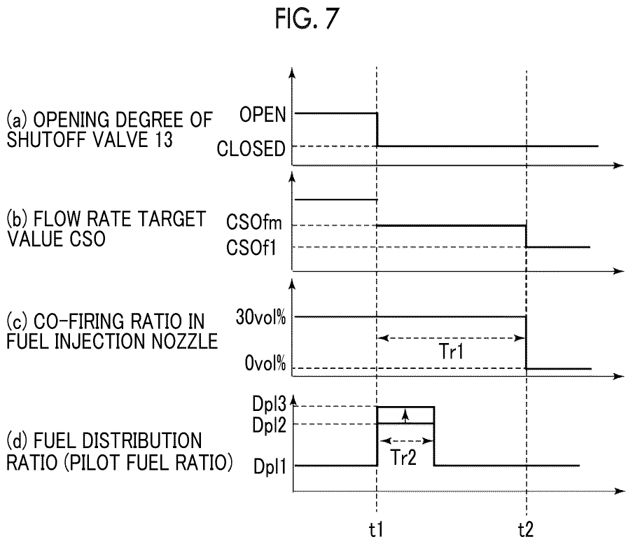

Subsequently, another embodiment will be described with reference to FIGS. 6 and 7. FIG. 6 is a block diagram illustrating a configuration example of the fuel distribution ratio setting unit 107 of FIG. 3, and FIG. 7 is a time chart illustrating a temporal transition of the opening degree of the shutoff valve 13, the flow rate target value CSO of the fuel supplied to the combustor 2, the co-firing ratio, and the pilot fuel distribution ratio Dp1 in a case where the load reduction request is acquired at the time point t1.

As illustrated in FIG. 6, the fuel distribution ratio setting unit 107 includes a basic fuel distribution ratio setting unit 114. The basic fuel distribution ratio setting unit 114 is configured to set the basic fuel distribution ratio. In the present embodiment, in particular, the basic fuel distribution ratio setting unit 114 sets the basic fuel distribution ratio to temporarily increase at the time of acquisition of the load reduction request. Specifically, the basic fuel distribution ratio generally has a first value Dpl1, but when the load reduction request is acquired at the time point t1, the basic fuel distribution ratio increases to a second value Dpl2 (>first value Dpl1) in a predetermined period Tr2. Then, when the predetermined period Tr2 elapses, the value returns to the first value Dpl1 again. In this way, when there is a load reduction request, the basic fuel distribution ratio is set to temporarily increase the fuel distribution ratio, so that abnormal combustion or misfire of the gas turbine 1 due to a load change can be effectively prevented.

The predetermined period Tr2 is set to be shorter than the predetermined period Tr1 described above, but the length relationship between the two is not limited, and the two may be the same.

The fuel distribution ratio setting unit 107 sets the fuel distribution ratio by correcting the increase rate of the basic fuel distribution ratio at the time of acquisition of the load reduction request based on the co-firing ratio. In FIG. 6, the fuel distribution ratio setting unit 107 sets the fuel distribution ratio by correcting the basic fuel distribution ratio using a second correction value A2 calculated based on the co-firing ratio.

The effectiveness/ineffectiveness of the correction using the second correction value A2 is performed by switching control of a switch T2 based on the load reduction request acquired by the load reduction request acquisition unit 102. The load reduction request acquired by the load reduction request acquisition unit 102 is input to a timer 116. The timer 116 is configured to output an ON command to the switch T2 for a predetermined period Tr2 from the time point t1 when the load reduction request is input. Meanwhile, in a case where the load reduction request is not acquired or even in a case where the load reduction request is acquired, the switch T2 is switched to OFF after the predetermined period Tr2 has elapsed from the acquisition time point t1.

In addition, in the fuel distribution ratio setting unit 107, the second correction value A2 is calculated by inputting the co-firing ratio acquired by the co-firing ratio acquisition unit 104 into a function FX2. The function FX2 is prepared in advance as a function that defines the correlation between the co-firing ratio and the second correction value A2. As described above, the output of the function FX2 is added to the basic fuel distribution ratio in the second value Dpl2 for a predetermined period Tr2, that is, while the switch T2 is turned ON, from the time point t1 when the load reduction request is acquired by the load reduction request acquisition unit 102. In this manner, the basic fuel distribution ratio Dpl2 is corrected by the second correction value A2, so that the fuel distribution ratio is set to a third value Dpl3 in the predetermined period Tr2.

In this way, the fuel distribution ratio setting unit 107 sets the increase rate of the fuel distribution ratio at the time of acquiring the load reduction request, based on the co-firing ratio. In this manner, even in a case where the second fuel F2 is shut off when the load of the gas turbine 1 is reduced, the fuel distribution ratio is corrected in accordance with a change in the co-firing ratio of the gas turbine 1, so that abnormal combustion or misfire can be prevented and the operating state of the gas turbine can be stably maintained.

In addition, it is possible to replace the components in the embodiment described above with well-known components as appropriate within the scope which does not depart from the concept of the present disclosure, and the embodiments described above may be combined with each other as appropriate.

For example, contents disclosed in each of the embodiments are understood as follows.

(1) A gas turbine control device according to one aspect is a gas turbine control device for controlling a gas turbine including a combustor capable of co-firing a first fuel and a second fuel having a lower calorific value per unit volume than the first fuel, the gas turbine control device including:
a load reduction request acquisition unit for acquiring a load reduction request for the gas turbine;
a co-firing ratio acquisition unit for acquiring a co-firing ratio of the combustor at a time of acquisition of the load reduction request;
a flow rate target value setting unit for setting a flow rate target value of the first fuel when the load reduction request is acquired; and
a fuel flow rate control unit for controlling a flow rate of the first fuel to the flow rate target value in a case where the load reduction request is acquired,
in which the flow rate target value setting unit sets a basic flow rate target value of the first fuel for realizing a load corresponding to the load reduction request by exclusive combustion of the first fuel, by correcting the basic flow rate target value based on the co-firing ratio.

According to the aspect of the above (1), the flow rate target value of the fuel to be supplied to the combustor in a case where the load reduction request is acquired is set based on the co-firing ratio. The flow rate target value is obtained by correcting a basic flow rate target value of the fuel for controlling the gas turbine such that the load value corresponding to the load reduction request is obtained by exclusively combusting the first fuel, based on the co-firing ratio. In this manner, even in a case where the fuel is throttled so as to reduce the load on the gas turbine in response to the load reduction request, the operating state of the gas turbine can be stably maintained.

(2) In another aspect, in the aspect of the above (1),
the flow rate target value setting unit sets the flow rate target value in a case where the load reduction request is acquired, to be greater than the basic flow rate target value, using a first target value calculated based on the co-firing ratio.

According to the aspect of the above (2), the flow rate target value of the fuel to be supplied to the combustor when the load reduction request is acquired is set to be larger than the basic flow rate target value corresponding to the exclusive combustion of the first fuel. In this manner, when the fuel flow rate is reduced such that the load of the gas turbine is reduced in response to the load reduction request, it is possible to prevent the operating state of the gas turbine from becoming unstable.

(3) In another aspect, in the aspect of the above (2),
the fuel flow rate control unit shuts off the second fuel in a case where the load reduction request is acquired, and
the flow rate target value setting unit sets the basic flow rate target value as the flow rate target value in a case where a predetermined period elapses from a time when the load reduction request is acquired.

According to the aspect of the above (3), the flow rate target value is changed to the basic flow rate target value on a condition that a predetermined period elapses from a point in time when the load reduction request is acquired. In this manner, since the predetermined period from the time point when the load reduction request is acquired is set to the flow rate target value greater than the basic flow rate target value, it is possible to suppress the instability of the operating state of the gas turbine due to the load change. Then, after the predetermined period has elapsed, the flow rate target value is set to the basic flow rate target value, so that the low-load operating state of the gas turbine due to the exclusive combustion of the first fuel can be stably transitioned to.

(4) In another aspect, in the aspect of the above (3),
the predetermined period is set based on a required time for a mixed fuel of the first fuel and the second fuel to reach the combustor from a joining portion between a first fuel supply path for supplying the first fuel and a second fuel supply path for supplying the second fuel.

According to the aspect of the above (4), the predetermined period in which the second fuel is shut off and the flow rate target value of the first fuel is set to be greater than the basic flow rate target value is set based on the required time for the mixed fuel of the first fuel and the second fuel to reach from the joining portion to the combustor when the load reduction request for the gas turbine is acquired. In this manner, when the second fuel is shut off, the flow rate target value of the first fuel is set to be greater than the basic flow rate target value until the mixed fuel remaining between the joining portion and the combustor reaches the combustor, so that it is possible to suppress the instability of the operating state of the gas turbine due to a load change. Then, after the predetermined period has elapsed, the flow rate target value is set to the basic flow rate target value, so that the low-load operating state of the gas turbine due to the exclusive combustion of the first fuel can be stably transitioned to.

(5) In another aspect, in any one aspect of the above (1) to (4),
the gas turbine further includes a fuel distribution ratio setting unit for setting a fuel distribution ratio to a plurality of different fuel injection nozzles included in the combustor,
in which the fuel distribution ratio setting unit sets the fuel distribution ratio to be temporarily increased when the load reduction request is acquired.

According to the aspect of the above (5), by setting the fuel distribution ratio to be temporarily increased at the time of acquiring the load reduction request, abnormal combustion or misfire of the gas turbine due to a load change can be effectively prevented.

(6) In another aspect, in the aspect of the above (5),
the fuel distribution ratio is a pilot fuel ratio that defines a fuel distribution ratio with respect to a pilot fuel injection nozzle among the plurality of different fuel injection nozzles.

According to the aspect of the above (6), the fuel distribution ratio to be controlled is set to the pilot fuel ratio, so that abnormal combustion or misfire of the gas turbine caused by a load change can be effectively prevented.

(7) In another aspect, in the aspect of the above (5) or (6),
the fuel distribution ratio setting unit sets an increase rate of the fuel distribution ratio at the time of acquisition of the load reduction request, based on the co-firing ratio.

According to the aspect of the above (7), the control target value of the fuel distribution ratio when the load of the gas turbine changes due to the acquisition of the load reduction request is set based on the co-firing ratio of the increase rate. In this manner, when the load of the gas turbine is reduced, the fuel distribution ratio is corrected according to the co-firing ratio of the gas turbine, so that abnormal combustion or misfire can be prevented and the operating state of the gas turbine can be stably maintained.

(8) In another aspect, in any one aspect of the above (1) to (7),
the gas turbine system further includes an abnormality detection unit for outputting the load reduction request in a case where an abnormality of the gas turbine is detected.

According to the aspect of the above (8), when an abnormality is detected in the gas turbine, the load reduction request is output. By acquiring the load reduction request output in this way as a trigger and performing the fuel flow rate control described above, when an abnormality is detected in the gas turbine, the load reduction control of the gas turbine can be performed while stably maintaining the operating state of the gas turbine.

(9) In another aspect, in any one aspect of the above (1) to (8), the load reduction request is a request for making a load of the gas turbine zero.

According to the aspect of the above (9), when the load of the gas turbine is reduced to zero in response to the load reduction request, the operating state of the gas turbine can be stably maintained.

(10) A gas turbine control method according to an aspect is a gas turbine control method for controlling a gas turbine including a combustor capable of co-firing a first fuel and a second fuel having a lower calorific value per unit volume than the first fuel, the gas turbine control method including:
a step of acquiring a load reduction request for the gas turbine;
a step of acquiring a co-firing ratio of the combustor at a time of acquisition of the load reduction request;
a step of setting a flow rate target value of the first fuel at a time of acquisition of the load reduction request; and
a step of controlling a flow rate of the first fuel to the flow rate target value in a case where the load reduction request is acquired,
in which in the step of setting the flow rate target value, a basic flow rate target value of the first fuel for realizing a load corresponding to the load reduction request by exclusive combustion of the first fuel is set by correcting the basic flow rate target value based on the co-firing ratio.

According to the aspect of the above (10), the flow rate target value of the fuel to be supplied to the combustor in a case where the load reduction request is acquired is set based on the co-firing ratio. The flow rate target value is obtained by correcting a basic flow rate target value of the fuel for controlling the gas turbine such that the load value corresponding to the load reduction request is obtained by exclusively combusting the first fuel, based on the co-firing ratio. In this manner, even when the fuel is throttled so as to reduce the load on the gas turbine in response to the load reduction request during the co-firing of the gas turbine, the operating state of the gas turbine can be stably maintained.

(11) A gas turbine control program according to an aspect is a gas turbine control program for controlling a gas turbine including a combustor capable of co-firing a first fuel and a second fuel having a lower calorific value per unit volume than the first fuel, the program causing a computer device to execute:
a step of acquiring a load reduction request for the gas turbine;
a step of acquiring a co-firing ratio of the combustor at a time of acquisition of the load reduction request;
a step of setting a flow rate target value of the first fuel at a time of acquisition of the load reduction request; and
a step of controlling a flow rate of the first fuel to the flow rate target value in a case where the load reduction request is acquired,
in which in the step of setting the flow rate target value, a basic flow rate target value of the first fuel for realizing a load corresponding to the load reduction request by exclusive combustion of the first fuel is set by correcting the basic flow rate target value based on the co-firing ratio.

According to the aspect of the above (11), the flow rate target value of the fuel to be supplied to the combustor in a case where the load reduction request is acquired is set based on the co-firing ratio. The flow rate target value is obtained by correcting a basic flow rate target value of the fuel for controlling the gas turbine such that the load value corresponding to the load reduction request is obtained by exclusively combusting the first fuel, based on the co-firing ratio. In this manner, even when the fuel is throttled so as to reduce the load on the gas turbine in response to the load reduction request during the co-firing of the gas turbine, the operating state of the gas turbine can be stably maintained.

### Reference Signs List

1: Gas turbine
2: Combustor
3: Compressor
4: Fuel supply system
6: Turbine
7: First fuel supply source
8: First fuel supply line
10: Flowmeter
13: Shutoff valve
14: Second fuel supply source
16: Second fuel supply line
18: First flow regulation valve
22: Main fuel supply line
24: Shutoff valve
25: Joining portion
26: Second flow regulation valve
28a, 28b, . . . : Fuel branch supply line
30a, 30b, . . . : Third flow regulation valve
32: Outer cylinder
34: Liner
36: Burner
38: End cover
40: Combustion chamber
44: Fuel distributor
46: Pilot burner
48: Main burner
50: Air hole plate
52: Main fuel injection nozzle
54: Air hole
56: Pilot fuel injection nozzle
100: Gas turbine control device
102: Load reduction request acquisition unit
103: Abnormality detection unit
104: Co-firing ratio acquisition unit
106: Flow rate target value setting unit
107: Fuel distribution ratio setting unit
108: Fuel flow rate control unit
F1: First fuel
F2: Second fuel

1. A gas turbine control device for controlling a gas turbine including a combustor capable of co-firing a first fuel and a second fuel having a lower calorific value per unit volume than the first fuel, the gas turbine control device comprising:
a load reduction request acquisition unit for acquiring a load reduction request for the gas turbine;
a co-firing ratio acquisition unit for acquiring a co-firing ratio of the combustor at a time of acquisition of the load reduction request;
a flow rate target value setting unit for setting a flow rate target value of the first fuel when the load reduction request is acquired; and
a fuel flow rate control unit for controlling a flow rate of the first fuel to the flow rate target value in a case where the load reduction request is acquired,
wherein the flow rate target value setting unit sets a basic flow rate target value of the first fuel for realizing a load corresponding to the load reduction request by exclusive combustion of the first fuel, by correcting the basic flow rate target value based on the co-firing ratio.

2. The gas turbine control device according to claim 1, wherein the flow rate target value setting unit sets the flow rate target value in a case where the load reduction request is acquired, to be greater than the basic flow rate target value, using a first target value calculated based on the co-firing ratio.

3. The gas turbine control device according to claim 2, wherein the fuel flow rate control unit shuts off the second fuel in a case where the load reduction request is acquired, and
the flow rate target value setting unit sets the basic flow rate target value as the flow rate target value in a case where a predetermined period elapses from a time when the load reduction request is acquired.

4. The gas turbine control device according to claim 3, wherein the predetermined period is set based on a required time for a mixed fuel of the first fuel and the second fuel to reach the combustor from a joining portion between a first fuel supply path for supplying the first fuel and a second fuel supply path for supplying the second fuel.

5. The gas turbine control device according to claim 1, further comprising a fuel distribution ratio setting unit for setting a fuel distribution ratio to a plurality of different fuel injection nozzles included in the combustor,
wherein the fuel distribution ratio setting unit sets the fuel distribution ratio to be temporarily increased when the load reduction request is acquired.

6. The gas turbine control device according to claim 5, wherein the fuel distribution ratio is a pilot fuel ratio that defines a fuel distribution ratio with respect to a pilot fuel injection nozzle among the plurality of different fuel injection nozzles.

7. The gas turbine control device according to claim 5, wherein the fuel distribution ratio setting unit sets an increase rate of the fuel distribution ratio at the time of acquisition of the load reduction request, based on the co-firing ratio.

8. The gas turbine control device according to claim 1, further comprising an abnormality detection unit for outputting the load reduction request in a case where an abnormality of the gas turbine is detected.

9. The gas turbine control device according to claim 1, wherein the load reduction request is a request for making a load of the gas turbine zero.

10. A gas turbine control method for controlling a gas turbine including a combustor capable of co-firing a first fuel and a second fuel having a lower calorific value per unit volume than the first fuel, the gas turbine control method comprising:
a step of acquiring a load reduction request for the gas turbine;
a step of acquiring a co-firing ratio of the combustor at a time of acquisition of the load reduction request;
a step of setting a flow rate target value of the first fuel at a time of acquisition of the load reduction request; and
a step of controlling a flow rate of the first fuel to the flow rate target value in a case where the load reduction request is acquired,
wherein in the step of setting the flow rate target value, a basic flow rate target value of the first fuel for realizing a load corresponding to the load reduction request by exclusive combustion of the first fuel is set by correcting the basic flow rate target value based on the co-firing ratio.

11. A gas turbine control program for controlling a gas turbine including a combustor capable of co-firing a first fuel and a second fuel having a lower calorific value per unit volume than the first fuel, the program causing a computer device to execute:
a step of acquiring a load reduction request for the gas turbine;
a step of acquiring a co-firing ratio of the combustor at a time of acquisition of the load reduction request;
a step of setting a flow rate target value of the first fuel at a time of acquisition of the load reduction request; and
a step of controlling a flow rate of the first fuel to the flow rate target value in a case where the load reduction request is acquired,
wherein in the step of setting the flow rate target value, a basic flow rate target value of the first fuel for realizing a load corresponding to the load reduction request by exclusive combustion of the first fuel is set by correcting the basic flow rate target value based on the co-firing ratio.
